(19) United States
(12) Patent Application Publication
(10) Pub. No.: US 2006/0201310 A1
(43) Pub. Date: Sep. 14, 2006

(54) Information processing apparatus, information recording/playback system and contents transfer method

(75) Inventors: Kazuhiro Takashima, Tokyo (JP); Hidehito Izawa, Hanno-shi (JP); Toshihiro Morohoshi, Kawasaki-shi (JP); Masao Iwasaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/374,082

(22) Filed: Mar. 14, 2006

(30) Foreign Application Priority Data
Mar. 14, 2005 (JP) 2005-071584

(51) Int. Cl. G10H 1/00

(52) U.S. Cl. 84/600

(57) ABSTRACT

One embodiment of the invention is useful when updating data of a database which is configured to take in data through a network, has a part to be updated, and takes in information of media stored in a local storage, and characterized by that a storage place assumed to have stored an image file is retrieved in a specific order, and an image file is obtained and downloaded, based on an instruction to transfer music data stored in a recorder to a player.

### CROSS-REFERENCE TO RELATED APPLICATIONS

This application is based upon and claims the benefit of priority from prior Japanese Patent Application No. 2005-071584, filed Mar. 14, 2005, the entire contents of which are incorporated herein by reference.

### BACKGROUND

1. Field

One embodiment of the invention relates to a contents transfer method of transferring contents to a portable contents playback device, and more particularly a transfer method of transferring music contents and additional information simultaneously, an information processing apparatus, and information recording/playback system.

2. Description of the Related Art

A portable music playback device (audio player) capable of storing digital music data in a solid memory (memory card) or a hard disc, and playing music has become popular in recent years.

Music data can be obtained from a CD (Compact Disc)/DVD standard optical disc or a public broadcast supplied through a space wave, terrestrial wave or a satellite, or by downloading from a specific server (distribution site).

For example, an artist name, tune title and related image data (hereinafter called jacket data or jacket image) may be attached to music data obtainable from the Internet, or music data supplied by CD and DVD.

Jpn. Pat. KOKAI Publication No. 2002-123273 discloses an information processing apparatus, which downloads music data, artist name, tune title, album title, release date and related image data from a distribution site (server) through the Internet by using a personal computer, and sends an audio player the image data together with these music data.

In the audio player (information processing apparatus), a jacket image can be obtained and transferred only when a jacket image is attached to music data. When a user tries to get a jacket image attached to downloaded music data or to attach another image file of the same artist to music data with no jacket image attached, the above audio player cannot satisfy the user.

This may weaken the user's willingness to get music data and play (transfer) the music data in a portable music playback unit. This raises in reducing the commercial value of music data is lowered in a music data distribution system (purchase by the user) using the Internet as a supply medium.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a music contents transfer system, or an information processing apparatus, to which an embodiment of the invention is applied;

FIG. 2 is an exemplary block diagram of a system configuration of the music contents transfer system according to an embodiment of the invention shown in FIG. 1;

FIG. 3 is an exemplary diagram showing an example of a main menu of a contents management unit in the music contents transfer system according to an embodiment of the invention shown in FIG. 1;

FIG. 4 is an exemplary diagram showing a contents management unit in the music contents transfer system according to an embodiment of the invention shown in FIG. 1, and an example of a data holding (storing) structure in a destination (player);

FIG. 5 is an exemplary diagram showing an example of a display corresponding to a procedure of transferring a jacket photo to a player in the music contents transfer system according to an embodiment of the invention shown in FIG. 1;

FIG. 6 is an exemplary diagram showing an example of a display corresponding to a procedure of transferring a jacket photo to a player in the music contents transfer system according to an embodiment of the invention shown in FIG. 1;

FIG. 7 an exemplary flowchart explaining an example of a method of obtaining a jacket photo to be transferred to an audio player in the music contents transfer system according to an embodiment of the invention shown in FIG. 1; and

FIG. 8 is an exemplary flowchart explaining another example of a method of obtaining a jacket photo to be transferred to an audio player in the music contents transfer system according to an embodiment of the invention shown in FIG. 1.

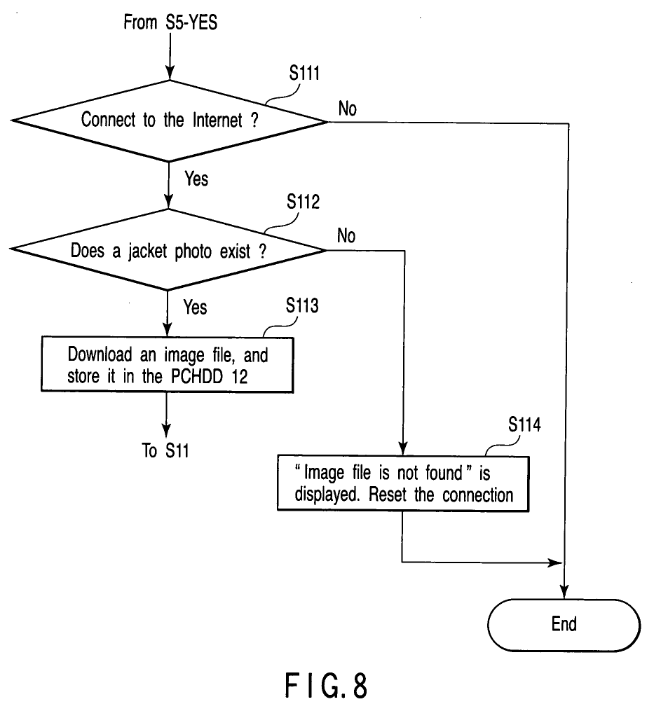

### DETAILED DESCRIPTION

Various embodiments according to the invention will be described hereinafter with reference to the accompanying drawings. In general, according to one embodiment of the invention is useful when updating data of a database which is configured to take in data through a network, has a part to be updated, and takes in information of media stored in a local storage, and characterized by that a storage place assumed to have stored an image file is retrieved in a specific order, and an image file is obtained and downloaded, based on an instruction to transfer music data stored in a recorder to a player.

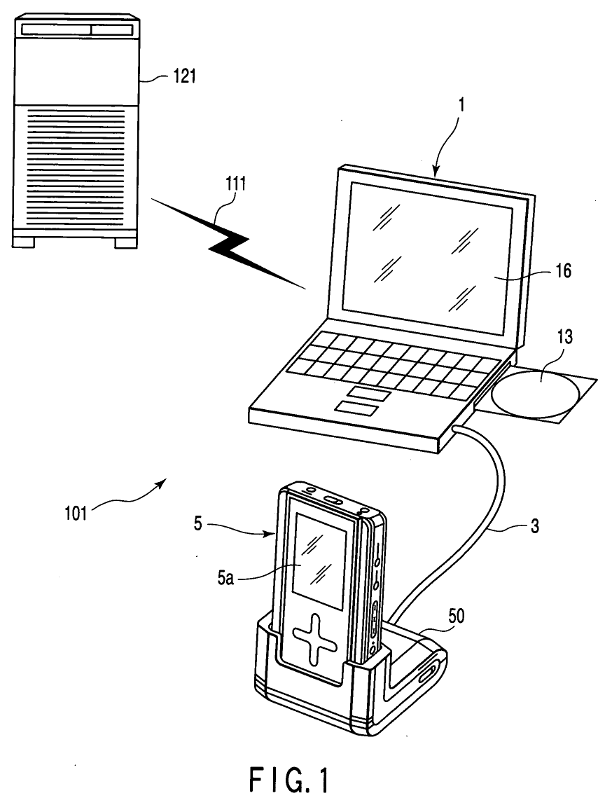

According to an embodiment FIG. 1 shows schematically the whole aspect of a music playback unit and an information recording/playback system, to which an embodiment of the present invention is applied.

As shown in FIG. 1, an information recording/playback system 101 includes a personal computer 1 (a contents management unit called a PC hereinafter) connectable to a music data suppler, or a server 121 of a distribution site through a network 111 represented by the Internet, and a portable music (contents) player 5 (hereinafter called an audio player) connectable to a PC 1 through a transmission line 3. The network 111 may be a LAN (Local Area Network) provided in the same building or in a limited area, a cable network, or a domestic LAN. The PC 1 may be a host computer or a relay server as long as data can be transferred with the audio player 5.

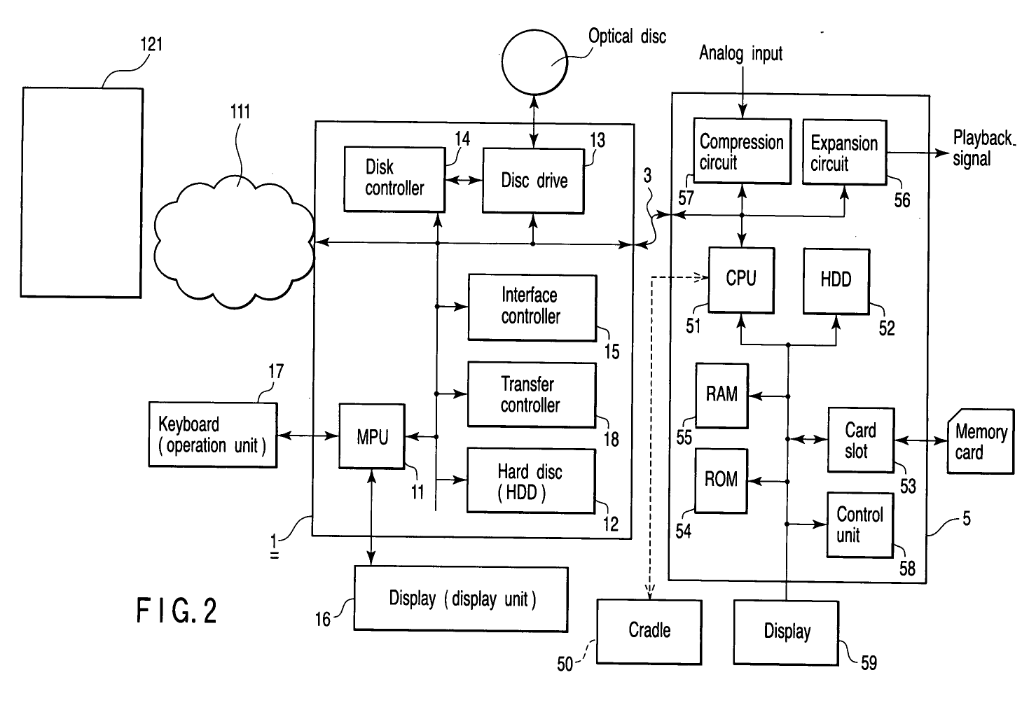

As shown in the block diagram of FIG. 2, the audio player 5 has a main controller 51 (hereinafter called a CPU), and a hard disc drive 52 (hereinafter called an HDD) given a fixed storage capacity. The HDD 52 can store music data (compressed data) and image data (compressed data) in an area except areas to store a firm ware (software to operate the audio player 5, and an application program to play music data supplied from the PC 1). The HDD 52 may be a mobile disc with a unit structure removable from the player 5. Though not described in detail, in addition to the HDD 52 (or instead of the HDD 52), at least one card slot 53 may be provided for transfer of data supplied from a semiconductor (solid body) memory, for example, an SD card, a mini-SD card (registered trademark), a compact flash (registered trademark), and a memory stick (registered trademark).

The audio player 5 has a system memory (ROM) 54 used for playing data stored in the HDD 52 or recording data in the HDD 52, starting the HDD 52, and controlling ON/OFF of a not-shown main power supply, a cache memory (RAM) 55 used for storing data temporarily, and an expansion circuit 56 to expand compressed data. The audio player 5 is also provided with a compression circuit 57 to compress an analog signal entered directly from a not-shown microphone or a line input terminal.

Music data 1 or image file (contents) compressed by the PC 1 is transferred to the HDD (mobile disc) 52, and recorded according to a specific rule. In the data compression, MP 3, WMA or WAV is used for the music data, and JPG, GIF or BMP is used for the image data. As the size of an image, 75 (pixels)×75 (pixels) or 200 (pixels)×200 (pixels) is set as an optimum size causing a small load in the player when paying back (displaying) the data.

Though not described in detail, data stored in the HDD 52 is encrypted to permit only direct playing with the player 5 and output to an external speaker as an analog signal, in order to prevent copying (except for the predetermined number of times) except for the private use as defined in the Copyright Act.

The operation of the player 5 can be controlled by an operation unit 58 including a multifunction button (cross-touch button) used for entering control commands such as for start/stop of playing, switching of information displayed in a display 5a, scrolling of words (letters) displayed in a display 5a.

As shown in the block diagram of FIG. 2, the PC 1 has a main processor 11 (hereinafter called a MPU) and a hard disc memory unit 12 (hereinafter called a PCHDD) of a fixed storage capacity. Though not explained in detail, the PC 1 also has a disc drive 13 which can read music information or image data from a CD/DVD standard optical disc, a disc controller 14 which reads information from an optical disc set in the disc drive 13 or controls the transfer of data for recording information on an optical disc, and an interface controller 15 used for transferring data with the audio player 5. As an interface, a USB (Universal Serial Bus) is usable. Namely, the transmission line 3 shown in FIG. 1 is a USB cable. The transmission line 3 is removable at a desired timing, and the PC 1 and player 5 has a connector (not shown) to connect the transmission line 3. The an interface may be of various known standards, such as, IEEE 1394/802, or a parallel bus.

The PC 1 is also provided with an LCD (Liquid Crystal Display) 16, and a keyboard 17 as an input unit to enter control information to execute download of music contents and transfer of music contents to the audio player 5.

The PCHDD 12 stores music contents (music data) as compressed digital data. The music contents stored in the PCHDD 12 is given an ID tag information (hereinafter called a tag information) in addition to data (music data file). The tag information includes an artist (singer name/player name), tune title, album title, jacket photo, etc.).

These information or data or files are compressed in the PC 1 according to the operation display of operations corresponding to the control commands entered from the keyboard 17 and display 16, and transferred to the audio player 5, when application software (not-explained in detail) held in the transfer controller 18 is started in the PC 1. Though not described in detail, the transfer controller 18 includes an extraction module to extract specific information from music contents (tag information), a conversion module to convert various information obtained from the server (site) 121 to specific formats, and an encryption module to encrypt music contents and obtained various information, and compresses or encrypts these music contents and obtained information to a transferable format.

Next, an explanation will be given on the data transfer between the PC and audio player, and data transfer from the PC to the player.

The PC 1 is installed with application software to form compressed data to be stored in the audio player 5, that is, a source including music data and image file represented by CD/DVD, or application for compressing contents supplied from a data supplier or a server to a specific format. When connecting (starting) the audio player 5 for the first time, it is necessary to install the application. In many cases, the application itself is stored in a specific area of the PCHDD 12, and started whenever the PC 1 is started.

When storing music contents from the PC 1 in the audio player 5, or when storing compressed music data in the HDD 52 of the player 5, there are two methods. One is to play a music CD set in the disc drive 13 and compress the played music as music data (ripping). The other is to access a distribution source (site) through the network 111 and download (compressed) music data from the site. When an optical disc set in the disc drive 13 is of a DVD standard, music played once by an application installed in the PC 1 is compressed again for an audio player.

When the audio player 5 is connected to the PC 1 through the transmission line (USB cable) 3 by using an attached cradle 50, the PC 1 detects the connection of the audio player 5, and a specific application preinstalled in the PC 1 is started.

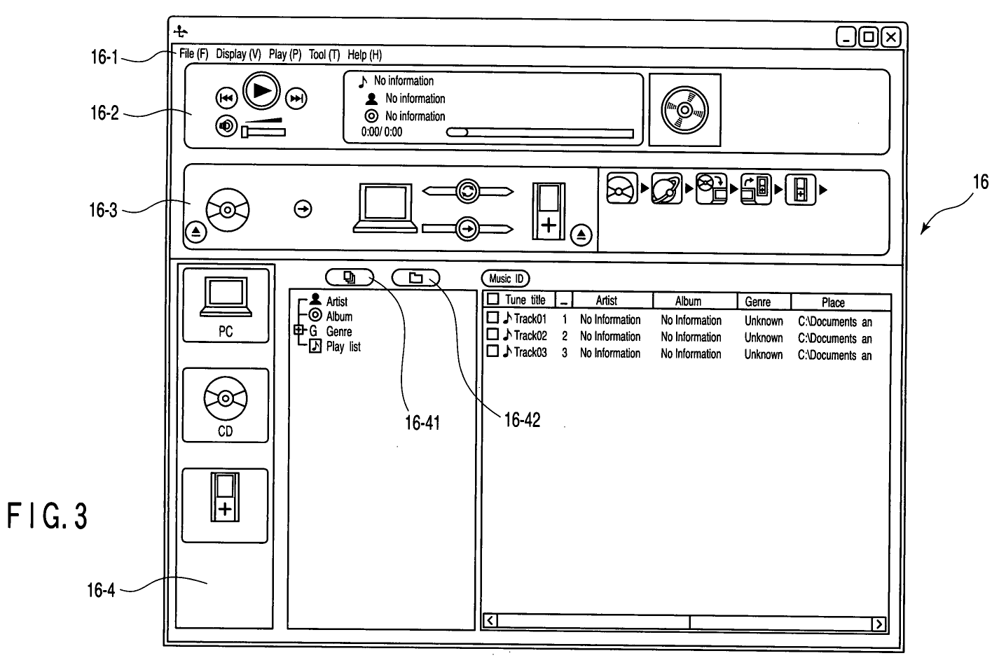

In this state, a menu screen (main screen) is displayed on the display 16 of the PC 1, as shown in FIG. 3, and the contents (compressed music data) stored in the PC 1 can be transferred to the audio player 5.

The menu screen includes a GUI (Graphical User, e.g., Interface) permits to instruct for operating by the user a menu bar area displaying 16-1 an operation indicating panel area displaying 16-2, a transfer operation control panel area displaying 16-3, and a device connecting indicating panel area displaying 16-4.

The menu bar area displaying 16-1 used to select an operation mode, e.g., File (F), Display (D), Play (P), Tool (T) and Help (H) each of the operation mode is described later. The operation indicating panel area displaying 16-2 to indicate an operating state, for example, play time up to now (passed time/total time (play time)), and a stored tune title. The transfer operation control panel area displaying 16-3 used to instruct a transfer (input a transfer start) to the audio player 5. The device connection indicating panel area displaying 16-4 used to switch and display a list of stored contents (music data) of the PCHDD 12 (PC main unit), optical disc (the optical disc stored in the current disc drive 13) and HDD 52 (audio player 5).

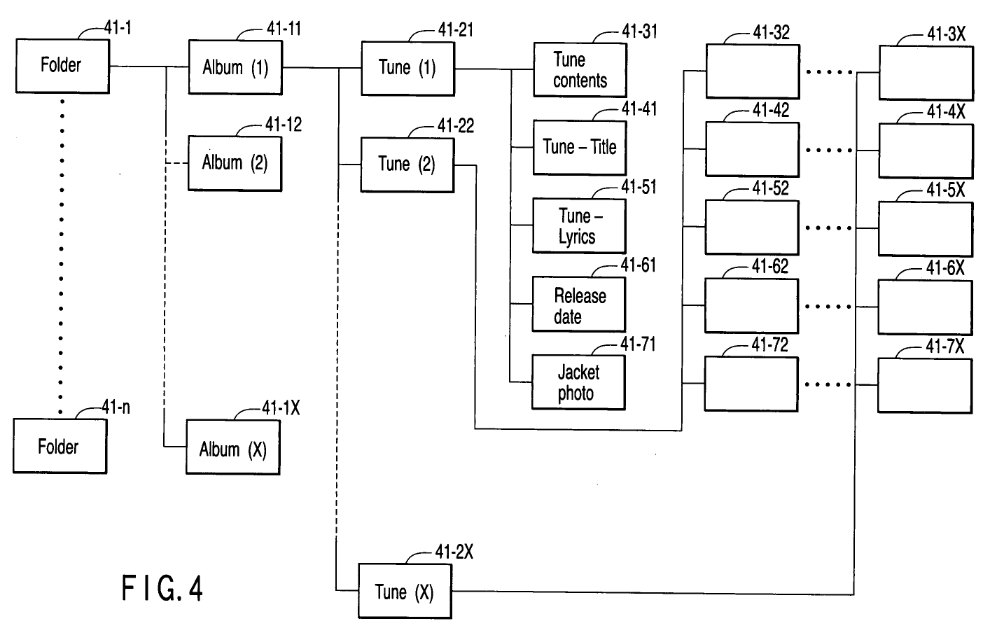

For example, the music data in the memory unit specified through the device connection indicating panel area displaying 16-4 is displayed in a tree structure, explained later with reference to FIG. 4 (by clicking the Display (button) on the display panel 16-4). The device connection indicating panel area displaying 16-4 instructs also a library view button area displaying 16-41 and a folder view button area displaying 16-42 used to switch the display of the contents list shown in a tree structure. The library view button area displaying 16-41 and folder view button area displaying 16-42 displays the selected library view or folder view, when any device is selected on the device connection indicating panel area displaying 16-4.

When the library view button area displaying 16-41 is clicked in this state, an optional number of folders classified based on a category, for example, “artist” area displaying, “album” area displaying and “genre” area displaying is displayed. When the folder view button area displaying 16-42 is clicked, a folder tree in each device is contained is displayed.

FIG. 4 shows an example of the data storing structure to store the music contents transferred from a PC to an audio player and additional information related to the music contents (e.g., an image file represented by a jacket photo), in the HDD of an audio player. The following data holding (storing structure) in the tree structure is almost the same in both PCHDD 12 of the PC 1 and HDD 52 of the player 5.

For example, a data storing structure corresponding to the library view is composed of folders 41-11 to 41-X specifiable by the album 1 to album X in the folders 41-1 to 41-n of the category specified by the artist A to artist n.

In the folders 41-11 to 41-1X of each album, the folders 41-21 to 41-2X of the tunes (n) (n: tune No.) contained (recorded) in that album are formed. A folder or file storing various data (hereinafter called a tag information), such as, tune-contents 41-31 to 41-3X, Tune—Titles 41-41 to 41-4X, Tune—Lyrics 41-51 to 41-5X, release dates 41-61 to 41-6X, and jacket photos (image files) 41-71 to 41-7X, is related to each folder of 41-41 to 41-41X. As for a jacket photo, when the source of an album is a CD, for example, the photo used for the jacket is made as an image file, and used for displaying on the display 5a of the player 5, while the tunes included in the album are being played back (or until the display is reset by the user).

Therefore, when an image file of a jacket photo (image) is added to the music data stored (contained) in the HDD 52 of the audio player 5, the jacket photo can be displayed in the display 5a while an optional tune of that album is being played back (or until the display is reset by the user).

When an album folder is formed for each tune and a jacket photo file is attached to each tune, namely, when music data is supplied from a one-tune supplier (source) generally called a single CD, a different jacket photo (image) is played back for each tune. As a jacket photo, data of a known file format, such as, JPG (JPEG), GIF and BMP can be used in many cases.

Next, an explanation will be given on a transfer of a jacket photo to an audio player, and a method of obtaining a jacket photo.

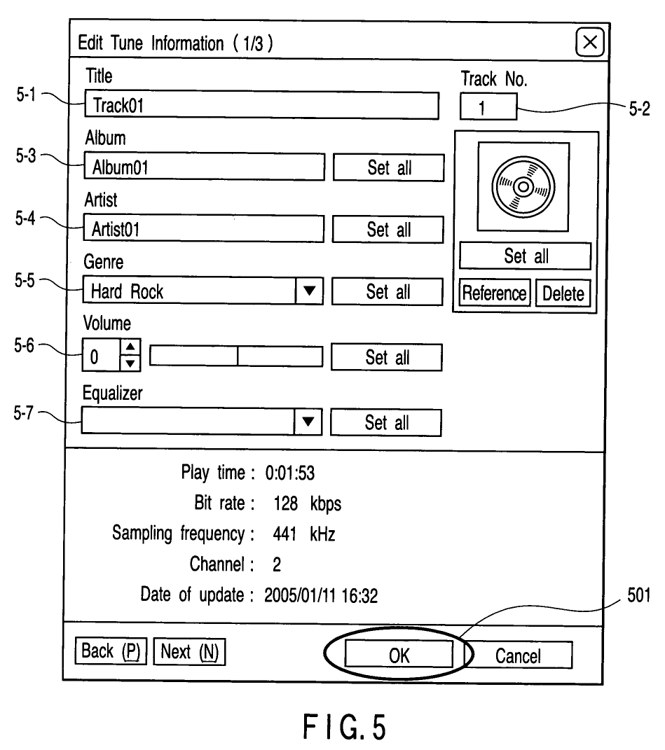

FIG. 5 shows the state that a tune information edit screen is displayed when Tool (T) area displaying and Edit Tune area displaying (not shown) are sequentially clicked in the menu bar area displaying 16-1 on the menu screen (main screen) explained in FIG. 3.

The tune information edit screen shown in FIG. 5 has more than one text box (seven (5-1 to 5-7) in this example) displayed for the entry of information based on the predetermined category, for example, 5-1 for a title, 5-2 for a track No., 5-3 for an album, 5-4 for an artist, 5-5 for a genre, 5-6 for a volume, and 5-7 for an equalizer. When the user clicks the OK button area displaying 501 after entering necessary information in a text box, the information entered in the respective test box is defined, and a library is updated.

The other area of the tune information edit screen has a display area 601 to display a jacket photo, a reference mode instruction button area displaying 602 to transfer a jacket photo displayed in the area 601 to the player 5 (to set a jacket image displayed now as a jacket photo in the area 601 as a jacket image corresponding to the music data held in the HDD 52 of the player 5), and a delete button area displaying 603 to cancel the display of a jacket image.

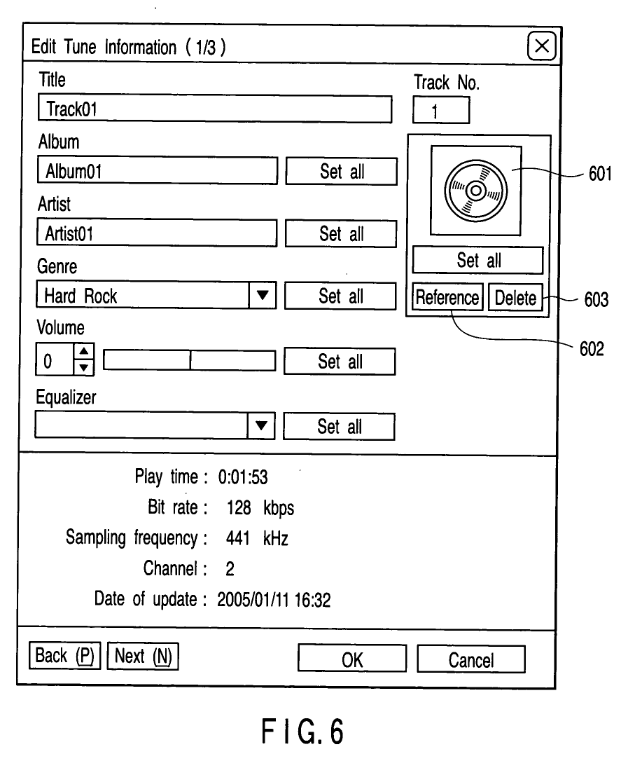

A jacket photo is displayed in the display area 601 shown in FIG. 6, when an image file is previously stored as a jacket photo in the PCHDD 12 and the tune information edit screen shown in FIG. 5 is displayed. Namely, when the tune information edit screen shown in FIG. 5 is displayed, the music data file or folder shown in FIG. 4, especially tag information, is referred to. When the tag information includes an image file, that image is displayed in the display area 601 (for a jacket photo) shown in FIG. 6. In this case, the displayed image size is, for example, 75 (pixels)×75 (pixels) or 200 (pixels)×200 (pixels), which are set as two preferable sizes with a minimum load when playing back (displaying) in the player. When the data is transferred from the PC 1, one file with a preset size is stored as tag information.

The jacket image displayed in the display area 601 is displayed in the display 5a of the audio player 5 (refer to FIG. 1), when the editing on the tune information edit screen is finished and an ordinary playback operation is started. When the jacket image is of a GIF file, an image with a predetermined specific operation can be displayed.

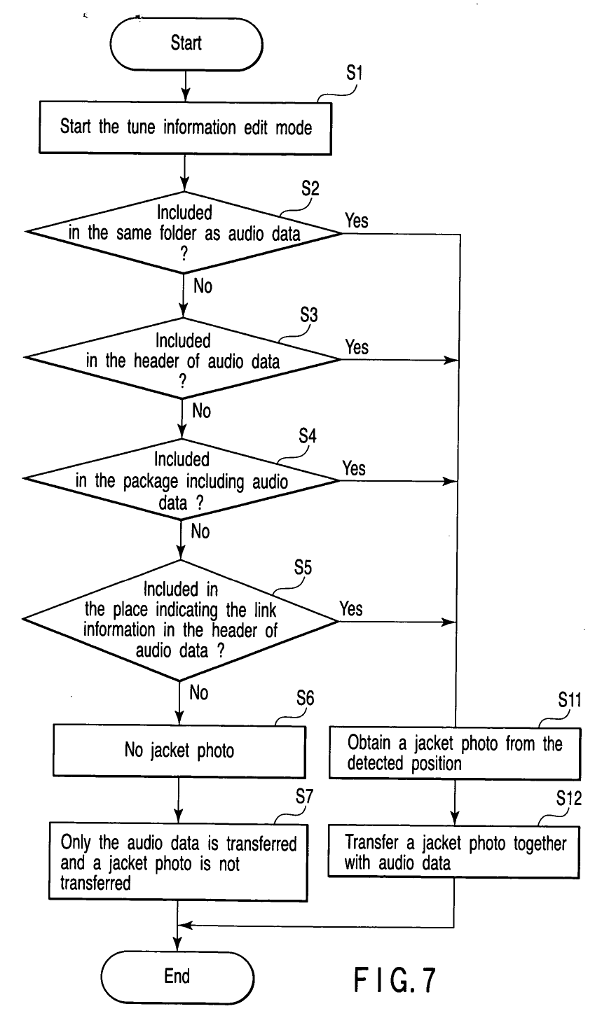

FIG. 7 is a flowchart explaining an example of a method of obtaining a jacket photo to be transferred to an audio player.

The tune information edit screen is started, and a jacket photo obtaining process is started (S1).

Audio data (music data) of a folder or file in the PCHDD 12 is referred to (S2).

When a jacket photo (image file) exists in the same folder as audio data in step S2 (S2—Yes), that image file is obtained as a jacket photo (S11), and transferred with audio data to the HDD 52 of the audio player 5 (S12).

When a jacket photo (image file) does not exist in the same folder as audio data in step S2 (S2—No), the tag information of a folder storing audio data is referred to (S3).

When a jacket photo (image file) exists in the tag information of a folder storing audio data in step S3 (S3—Yes), an image file is obtained as a jacket photo (S11), and transferred with audio data to the HDD 52 of the player 5 (S12).

In step S3, a package containing a jacket photo (image file) including audio data is referred to (S4).

When a file composed of a jacket photo (image file) or substitutable image information exists in a package including audio data in step S4 (S4—Yes), an image file in the package is obtained as a jacket photo (S11) and transferred with audio data to the HDD 52 of the player 5 (S12).

When a file composed of a jacket photo (image file) or substitutable image information does not exist in a package including audio data in step S4 (S4—No), a folder storing audio data is checked for the existence of an area having link information (in the PCHDD 12 of the PC 1) (S5).

When a file composed of a jacket photo (image file) or substitutable image information exists in an area showing link information (in the PCHDD 12 of the PC 1) of a folder storing audio data in step S5 (S5—Yes), an image file is obtained as a jacket photo by accessing its destination (S11) and transferred with audio data to the HDD 52 of the player 5 (S12).

When an area having link information (in the PCHDD 12 of the PC 1) does not exist in a folder storing audio data in step S5 (S5—No), it is judged to have no jacket photo (S6), and only audio data is transferred to the player 5 (S7).

When an area having link information is a web site accessed through the network 111 (refer to FIG. 1) in step S5, approval for the connection to the network is checked by “Connect to the Internet?”, for example (Sl11).

When the approval for the connection to the network is obtained in step S111 (connectable, S111—Yes), the connected destination link is checked for the existence of a jacket photo (image file) (S112).

When a jacket photo (image file) exists in the connected destination link in step S112 (S112—Yes), an image file is downloaded from that destination link and stored in a specific area of the PCHDD 12 (S113). The image file downloaded and stored in the specific area is obtained as a jacket photo according to S11 in FIG. 7, and transferred with audio data to the HDD 52 of the player 5.

When a jacket photo (image file) does not exist in the connected destination link in step 112 (S112—No), a message “Image file is not found”, for example, is displayed, and the connection to the Internet is reset (S114).

The size of a detected image (jacket photo) is resized from the detected size to the size displayable in the player 5, if necessary. Namely, in files other than an image file prepared previously for a jacket photo, the image size may be larger than the size of the display 5a of the player 5. Particularly, in files other than an image file prepared previously for a jacket photo, the image size may be 2048 (pixels)×1536 (pixels), 1024 (pixels)×768 (pixels), 800 (pixels)×640 (pixels) in not a few case. Therefore, when an image file (jacket photo) is transferred from the PC 1 to the player 5, the image size is converted to the size displayable easily in the player 5 (without converting the image) in the preceding stage, and a jacket photo (image file) can be played back (displayed) instantly in the player 5.

A method of resizing and a configuration of a resizing circuit (image processing circuit) used for the resizing are well known, and detailed explanation will be omitted. It is widely known to change the size of an image file downloaded and saved in the PCHDD 12, in a not-shown cache memory of the PCHDD 12 or in a not-shown RAM (work memory), under the control of the MPU 11 or the transfer controller 18, or by using firmware (an image processing application).

When a jacket photo is transferred from the PC 1 to the audio player 5, the image size is converted to be easily displayable in the player 5. This eliminates the necessity of a function for changing an image size in the player 5. Therefore, the player 5 is increased in the memory capacity to store music data and jacket photo files.

As for a file format (for an image file), a PC transfers only a file playable in a player, and it is unnecessary to prepare a decode function to interpret a file format. This increases the capacity of a player to store music data and jacket photos.

In a web site connected through the Internet, a jacket photo (image file) usable as a jacket photo may exist in more than two different sizes or images. While an image of a specific size is free of charge, a large size image may be charged (a charging system).

In such a case, identification of a downloading image file or approval for the charging may become necessary according to a menu in the web site. However, detailed explanation will be omitted.

As explained above, in the embodiment of the present invention, when the user instructs a transfer of audio data, a jacket photo (data) is retrieved in a specific order, that is, a) in the same folder as the audio data, b) in the header of the audio data itself, c) in a package provided with the audio data and jacket data in one piece (data package), and d) when a place of the jacket data (photo) is indicated as link information in the header of the audio data, retrieve or access the destination link.

Jacket data found first is transferred to a player as a jacket photo together with audio data (music). If jacket data is not found, only audio data is transferred without a jacket photo. Therefore, concerning the audio data for which jacket data is prepared, the time required by the user for retrieval can be remarkably reduced.

Further, when a jacket photo is transferred from a PC to an audio player, the image size is converted to be easily displayable in a player. This eliminates the necessity of a function for changing an image size in a player. Therefore, a player is increased in the memory capacity to store music data and jacket photo files.

As explained above, the present invention makes it possible to transfer music data containable (storable) in a portable music playback unit by attaching a jacket image or the user's favorite image file instead of a jacket image. Therefore, the user of a music playback unit can play back (display) also an image file or jacket image of a player (artist) of that music data during the playback of optional music data. This increases the user's satisfaction, and increases the user's desire to purchase charged music data supplied only from the Internet, for example.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Each embodiment may be appropriately combined as far as possible. In this case, the effect by combination will be obtained. For example, contents information is explained as audio information. But, the invention is not limited to this, and applicable widely to video information and others. Therefore, the invention is to be expanded over a wide range not contradictory to the disclosed principle and novel characteristics, and not to be limited to the embodiment described hereinbefore.

What is claimed is:

1. An information processing apparatus to transfer contents to a contents playback unit, comprising:
a recorder which holds contents;
an image file detector which detects an image file related to the contents, based on an instruction to transfer the contents stored in the recorder to a contents playback unit;
a transfer unit which transfers an image file playable in the contents playback unit together with the contents, when the image file is detected by the image file detector; and
a connector which is configured to connect a signal transmission mechanism, which is configured to connect the transfer unit to the contents playback unit, so that the image file and contents are transferred from the transfer unit to the contents playback unit.

2. The information processing apparatus according to claim 1, wherein the signal transmission mechanism includes a USB interface, and the transfer unit is started when the connection of the contents playback unit through the signal transmission mechanism is detected.

3. The information processing apparatus according to claim 1, wherein the detector retrieves a storage area assumed to have stored the image file in a specific order, before the transfer unit transfers the image file.

4. The information processing apparatus according to claim 1, further comprising an image processing unit which converts the size/file format of the image file to the size/file format of an image file playable in the contents playback unit, when the size of the image file detected by the detector is larger than the size of an image file playable in the contents playback unit, or when the format of the image file is different from the format of an image file playable in the contents playback unit.

5. An information recording/playback system comprising:
an information playback unit which has a data storage and an image display, and is configured to play music data supplied from outside and image information related to the music data;
a data management unit;
a data holder which holds music data;
a data take-in unit which takes data connectable through a network, music data from a supplier or a data supply medium, or music signal and image file before conversion, into the data holder;
an image information detector which detects the existence of an image file related to music data, when an instruction to transfer the music data held by the data holder to the information playback unit is given;
a transfer unit which transfers an image file to the information playback unit together with the music data held in the data holder, when the image information detector detects an image file playable in the information playback unit; and
a signal transmission mechanism which is configured to connect the transfer unit to the information playback unit, so that the image file and music data are transferred from the transfer unit to the information playback unit.

6. The information recording/playback system according to claim 5, wherein the signal transmission mechanism includes a USB interface, and starts the transfer unit when the connection of the information playback unit is detected.

7. The information recording/playback system according to claim 5, wherein the data take-in unit retrieves a storage area assumed to have stored an image file in a specific order, before the transfer unit transfers an image file.

8. The information recording/playback system according to claim 7, wherein when an instruction is given to the transfer unit to transfer an image file, the data take-in unit retrieves an image file in a specific order, that is, the same folder as music data, a header of music data itself, a data package provided with music data and image file in one piece, and a destination link when the place of jacket data is indicated as link information in the header of music data.

9. The contents management unit according to claim 5, further comprising an image processing unit which converts the size/file format of an image file to the size/file format of an image file playable in the information playback unit, when the size of the image file detected by the data take-in unit is larger than the size of an image file playable in the information playback unit, or when the format of the image file is different from the format of an image file playable in the information playback unit.

10. A contents transfer method, wherein when data to be transferred to a portable playback unit connected to a contents management unit is transferred to the portable playback unit, image data attached to audio data is obtained by retrieving a storage place assumed to have stored the image file.

11. The contents transfer method according to claim 10, wherein image data retrieved as a jacket photo is converted to a format or size playable in a playback unit.
